(19) United States
(12) Patent Application Publication
(10) Pub. No.: US 2010/0119854 A1
(43) Pub. Date: May 13, 2010

(54) PRIMER COMPOSITION FOR ACRYLIC ADHESIVE, BONDING METHOD AND ASSEMBLY

(75) Inventors: Yuki Hisha, Gunma (JP); Kimihiko Yoda, Gunma (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Denki Kagaku Kogyo Kabushiki Kaisha, Tokyo (JP)

(21) Appl. No.: 12/594,693

(22) PCT Filed: Apr. 2, 2008
(86) PCT No.: PCT/JP2008/056607

§ 371 Date: Oct. 5, 2009

(30) Foreign Application Priority Data
Apr. 4, 2007 (JP) 2007-098650

(51) Int. Cl. B32B 27/36; C09K 3/00

(52) U.S. Cl. 428/500; 252/182.13; 156/332

(57) ABSTRACT

To provide a primer composition for assisting an acrylic adhesive which exhibits a temporarily fixing effect very quickly and which is completely cured quickly at room temperature, while maintaining excellent characteristics of the acrylic adhesive.

A primer composition, which comprises a component (A): a basic compound having a primary, secondary or tertiary amine structure, a component (B): a liquid oligomer, and a component (C): a solvent. Preferably, the component (A) is a compound having a main chain of which the skeleton is ethyleneimine, or ethyleneimine having a molecular weight of from 50 to 70,000. Further, a bonding method, which comprises applying the above primer composition on a surface of an object to be bonded by dot coating, and bonding the object to another object to be bonded by means of the acrylic adhesive.

### TECHNICAL FIELD

The present invention relates to a primer composition excellent in high speed curing properties such as being easily cured at room temperature for assisting strong bonding, a bonding method and an assembly. Particularly, it relates to a primer composition for an acrylic adhesive, suitable for the furniture made of a steel plate, office articles, etc., and a bonding method and an assembly using the composition.

### BACKGROUND ART

An acrylic adhesive is used for bonding by polymerizing and curing an acrylic monomer or oligomer utilizing an organic peroxide and a reducing agent which decomposes the organic peroxide to generate radicals, as a polymerization initiator.

A combination of an organic peroxide with a reducing agent is generally called “a curing initiator system”. Further, a “two-pack type acrylic adhesive” is an acrylic adhesive having the curing initiator components separated into two agents of (A) a composition containing an organic peroxide and (B) a composition containing a reducing agent, and it is also called a two liquid chief agent type adhesive since the two agents (A) and (B) are in the form of a liquid in most cases.

The two-pack type acrylic adhesive is used for a method of mixing the above two agents (A) and (B) immediately before use and applying the mixture to an object to be bonded, and a method of applying the above (A) to a surface of one object to be bonded and applying the above (B) on a surface of the other object to be bonded, and contacting both surfaces.

A conventional two-pack type acrylic adhesive requires a curing time of several minutes to several hours until fixing, and an adhesive which is cured at a high speed at room temperature as compared with an epoxy adhesive has been developed (Patent Documents 1 to 4).

Patent Document 1: JP-A-52-018478

Patent Document 2: U.K. Patent No. GB 715382

Patent Document 3: U.S. Pat. No. 3,591,438

Patent Document 4: U.S. Pat. No. 3,625,930

However, even with use of such an acrylic adhesive by itself, no adhesive which is cured within about 10 seconds at room temperature, which is so-called “cured in seconds”, while maintaining final adhesive characteristics, has been realized. Accordingly, a temporarily fixing jig is used for the purpose of preventing misalignment in the bonding position or falling, from bonding till fixing by curing at present.

In a case of using an acrylic adhesive at present, a lot of temporarily fixing jigs must be used in the bonding site, and for example, productivity in production of steel plate products cannot be improved, thus preventing the cost reduction. A bonding method which can bond an object at a determined position without use of a temporarily fixing jig, which overcomes the above defect, has been strongly desired.

### DISCLOSURE OF THE INVENTION

### Object To Be Accomplished By the Invention

The present invention has been made to overcome the above problems of prior art, and its object is to provide a primer composition for assisting an acrylic adhesive which exhibits a temporarily fixing effect very quickly and which is completely cured quickly at room temperature while maintaining excellent characteristics of the acrylic adhesive.

### Means To Accomplish the Object

That is, the present invention provides the following.
(1) A primer composition for an acrylic adhesive, which comprises the following components (A), (B), and (C):

component (A): a basic compound having a primary, secondary or tertiary amine structure,

component (B): an oligomer, and

component (C): a solvent.
(2) The primer composition according to the above (1), which comprises 0.5 to 5 parts by mass of the component (A), from 10 to 90 parts by mass of the component (B), and from 10 to 90 parts by mass of the component (C) based on 100 parts by mass of the total of the components (B) and (C).
(3) The primer composition according to the above (1) or (2), wherein the basic compound as the component (A) is a compound having a main chain of which the skeleton is ethyleneimine.
(4) The primer composition according to any one of the above (1) to (3), wherein the basic compound as the component (A) is ethyleneimine having a number average molecular weight of from 50 to 70,000.
(5) The primer composition according to any one of the above (1) to (4), wherein the basic compound as the component (A) is ethyleneimine having an amine value of from 5 to 25 mmol/g-solid in one molecule.
(6) The primer composition according to any one of the above (1) to (5), wherein the acrylic adhesive comprises (A′) a polymerizable acrylic composition, (B′) an organic peroxide and (C′) a reducing agent.
(7) The primer composition according to the above (6), wherein the acrylic adhesive comprises 100 parts by mass of (A′) the polymerizable acrylic composition, from 0.1 to 10 parts by mass of (B′) the organic peroxide, and from 0.04 to 5 parts by mass of (C′) the reducing agent.
(8) The primer composition according to the above (6) or (7), wherein (A′) the polymerizable acrylic composition contains (A-1) a multifunctional (meth)acrylate and (A′-2) a monofunctional (meth)acrylate.
(9) The primer composition according to the above (8), wherein (A′-2) the monofunctional (meth)acrylate contains (A′-2-1) a hydroxylalkyl(meth)acrylate and (A′-2-2) a (meth)acrylate other than the hydroxylalkyl(meth)acrylate.
(10) A bonding method, which comprises applying the primer composition as defined in any one of the above (1) to (9) on a surface of an object to be bonded, and bonding the object to another object to be bonded by means of the acrylic adhesive.
(11) The bonding method according to the above (10), wherein the application method is dot coating.
(12) An assembly, which is produced by bonding objects by the bonding method as defined in the above (10) or (11).

### Effects of the Invention

The primer composition of the present invention quickly reacts with an acrylic adhesive, is cured and exhibits a temporarily fixing effect.

### BEST MODE FOR CARRYING OUT THE INVENTION

In the present invention, the component (A) is a basic compound having a primary, secondary or tertiary amine structure, and is a material which reacts with a reducing agent in the acrylic adhesive to decompose an organic peroxide at a high speed and thereby exhibits a function to quickly cure the adhesive. Such a compound may, for example, be a polyethyleneimine, a modified polyethyleneimine (manufactured by NIPPON SHOKUBAI CO., LTD.), N,N-dimethylanyline, modified dihydropyridine, 2-methylimidazole, 2-hydroxyethyl p-toluidine, ethanolamine, diethanolamine, diethylethanolamine, methyldiethanolamine, butyldiethanolamine, diethylamine, triethylamine, n-butylamine, 2,2-bipyridine, 1,10-phenanthroline, ammonia, alkylidene malonate, 6-iminomalonate, ethylazan, phenylamine, benzylamine, 1-benzofuran-2-amine, 4-quinolylamine, pentane-1,2,5-triamine, benzene-1,2,4,5-tetramine, bis(2-chloroethyl)amine, butyl(ethyl)methylamine, (2-chloroethyl)(propyl)amine, hexane-1-imine, isopropylidene amine, ethane-1,2-diimine, carbodiimide, o-acetylhydroxyamine, o-carboxyhydroxylamine, hydroxylamine-o-sulfonic acid, o-hydroxyaniline, phenylpropanolamine hydrochloride, catecholamine, indoleamine, polyacrylamine or dicyclohexylcarbodiimide.

Among the above compounds, a compound having a main chain of which the skeleton is ethyleneimine is preferably selected for the reasons of high curing properties and the safety. Such a compound may, for example, be polyethyleneimine or modified polyethyleneimine (EPOMIN manufactured by NIPPON SHOKUBAI CO., LTD.).

Further, the component (A) is preferably ethyleneimine having a number average molecular weight of from 50 to 70,000, more preferably from 200 to 800.

The component (A) is preferably ethyleneimine having an amine value of from 5 to 25 mmol/g-solid in one molecule from the viewpoint of high speed curing properties, more preferably ethyleneimine having an amine value of from 10 to 20 mmol/g-solid in one molecule. When the number average molecular weight is at least 50, curing will occur, and when the number average molecular weight is at most 70,000, the resin will not be flexible.

The components (A) may be used as a mixture of two or more of them for the purpose of improving the handling efficiency and the performance, and its amount is preferably from 0.5 to 5 parts by mass, more preferably from 1 to 4 parts by mass per 100 parts by mass of the total of the components (B) and (C). When it is at least 0.5 part by mass, the curing rate will be sufficient since the composition will be cured within several tens seconds, and when it is at most 5 parts by mass, the final strength will not be low.

The component (B) is an oligomer, preferably a liquid oligomer. The liquid oligomer may, for example, be a liquid acrylic oligomer such as “NISSO-PB TEAI-1000” manufactured by Nippon Soda Co., Ltd. (both terminal acrylate-modified hydrogenated butadiene oligomer), “NISSO-PB TE-2000” manufactured by Nippon Soda Co., Ltd. (both terminal methacrylate-modified butadiene oligomer), “UC-203” manufactured by KURARAY CO., LTD. (an ester oligomer of a maleic anhydride adduct of an isoprene polymer with 2-hydroxyethyl methacrylate) or “ARUFON UP-1000” series manufactured by TOAGOSEI CO., LTD. (a non-functional group resin nonstyrene type acrylic oligomer); a cyclopentadiene resin such as “Quintone 1000” series manufactured by ZEON CORPORATION (alicyclic hydrocarbon resin); or a petroleum resin such as “Nisseki Neopolymer” manufactured by Nippon Oil Corporation (aromatic petroleum resin) or “ARKON” manufactured by Arakawa Chemical Industries, Ltd. (alicyclic saturated hydrocarbon resin). Among them, in view of the storage stability, preferred is a liquid acrylic oligomer such as “NISSO-PB TEAI-1000” manufactured by Nippon Soda Co., Ltd. or “ARUFON UP-1000” series.

Among the above oligomers, the component (B) is preferably an oligomer having a number average molecular weight of from 100 to 10,000 in view of complete curing, more preferably an oligomer having a number average molecular weight of from 500 to 5,000. When the number average molecular weight is at least 100, a portion coated with the primer composition will be cured, and when the number average molecular weight is at most 10,000, the resin will be cured without being flexible.

The component (B) is used in an amount of preferably from 10 to 90 parts by mass, more preferably from 30 to 70 parts by mass per 100 parts by mass of the total of the components (B) and (C). When it is at least 10 parts by mass, the stirring efficiency will not be low, and when it is at most 90 parts by mass, high speed curing properties will be achieved.

The component (C) is a solvent and imparts a function to control wet spreading of the primer according to the form of application of the primer. Such a solvent may, for example, be isopropyl alcohol, acetone, ethyl acetate, methanol, ethanol, butanol, toluene, tetrahydrofuran, hexane, N,N-dimethylformamide, N,N-dimethylsulfoxide, benzene, chloroform, dichloromethane or trifluoromethane.

The component (C) is used in an amount of preferably from 10 to 90 parts by mass, more preferably from 30 to 70 parts by mass per 100 parts by mass of the total of the components (B) and (C). When it is at most 10 parts by mass, the storage stability will not be low, and when it is at most 90 parts by mass, the stirring efficiency will not be low.

Further, for the primer composition of the present invention, a small amount of a polymerization inhibitor may be added for the purpose of improving the storage stability. For example, a phenolic stabilizer such as hydroquinone, pyrogallol or monomethyl hydroquinone may be added.

Further, for the purpose of improving fluidity or the like, a bulking agent such as high purity ultrafine silica powder may be added to an extent such that the storage stability is not impaired.

Further, for the purpose of improving characteristics, a silane coupling agent, an amine salt of (meth)acrylate ethanol phosphate or the like may be added.

The acrylic adhesive of the present invention preferably comprises (A′) a polymerizable acrylic composition, (B′) an organic peroxide and (C′) a reducing agent.

(A′) The polymerizable acrylic composition preferably contains (A-1) a multifunctional (meth)acrylate and (A′-2) a monofunctional (meth)acrylate.

(A-1) The multifunctional (meth)acrylate may be a multifunctional (meth)acrylate oligomer/polymer (meth)acrylated at two or more positions at terminals or in the side chains of the oligomer/polymer, or a monomer having at least 2 (meth)acryloyl groups. For example, the multifunctional (meth)acrylate oligomer/polymer may, for example, be 1,2-polybutadiene-terminated urethane(meth)acrylate (e.g. TE-2000, TEA-1000 manufactured by Nippon Soda Co., Ltd.), a hydrogenated product of the above (meth)acrylate (e.g. TEAI-1000 manufactured by Nippon Soda Co., Ltd.), 1,4-polybutadiene-terminated urethane(meth)acrylate (e.g. BAC-45 manufactured by OSAKA ORGANIC CHEMICAL INDUSTRY Ltd.), polyisoprene-terminated (meth)acrylate, polyester urethane(meth)acrylate, polyether urethane(meth)acrylate, polyester(meth)acrylate or bis A epoxy(meth)acrylate (e.g. VISCOAT #540 manufactured by OSAKA ORGANIC CHEMICAL INDUSTRY, LTD. or VISCOAT VR-77 manufactured by SHOWA HIGHPOLYMER CO., LTD.)

As a bifunctional (meth)acrylate monomer, 1,3-butylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dicyclopentanyl di(meth)acrylate, 2-ethyl-2-butyl-propanediol(meth)acrylate, neopentyl glycol-modified trimethylolpropane di(meth)acrylate, stearic acid-modified pentaerythritol diacrylate, polypropylene glycol di(meth)acrylate, 2,2-bis(4-(meth)acryloxydiethoxyphenyl)propane, 2,2-bis(4-(meth)acryloxypropoxyphenyl)propane or 2,2-bis(4-(meth)acryloxytetraethoxyphenyl)propane may, for example, be mentioned.

As a trifunctional (meth)acrylate monomer, trimethylolpropane tri(meth)acrylate or tris[(meth)acryloxyethyl]isocyanurate may, for example, be mentioned.

As a tetrafunctional or higher functional (meth)acrylate monomer, dimethylolpropane tetra(meth)acrylate, pentaerythritol tetra(meth)acrylate, pentaerythritolethoxy tetra(meth)acrylate, dipentaerithritol penta(meth)acrylate or dipentaerithritol hexa(meth)acrylate may, for example, be mentioned.

(A′-2) The monofunctional (meth)acrylate monomer may, for example, be methyl(meth)acrylate, ethyl(meth)acrylate, propyl(meth)acrylate, butyl(meth)acrylate, 2-ethylhexyl(meth)acrylate, isooctyl(meth)acrylate, isodecyl(meth)acrylate, lauryl(meth)acrylate, stearyl(meth)acrylate, phenyl(meth)acrylate, cyclohexyl(meth)acrylate, dicyclopentanyl(meth)acrylate, dicyclopentenyl(meth)acrylate, dicyclopentenyloxyethyl(meth)acrylate, isobornyl(meth)acrylate, methoxylated cyclodecatriene(meth)acrylate, 2-hydroxyethyl(meth)acrylate, 2-hydroxypropyl(meth)acrylate, 3-hydroxypropyl(meth)acrylate, 4-hydroxybutyl(meth)acrylate, tetrahydrofurfuryl(meth)acrylate, 2-hydroxy-3-phenoxypropyl(meth)acrylate, glycidyl(meth)acrylate, caprolactone-modified tetrahydrofurfuryl(meth)acrylate, 3-chloro-2-hydroxypropyl(meth)acrylate, N,N-dimethylaminoethyl(meth)acrylate, N,N-diethylaminoethyl(meth)acrylate, t-butylaminoethyl(meth)acrylate, ethoxycarbonylmethyl(meth)acrylate, phenol ethylene oxide-modified acrylate, phenol (ethylene oxide 2 mol-modified) acrylate, phenol (ethylene oxide 4 mol-modified) acrylate, p-cumylphenol ethylene oxide-modified acrylate, nonylphenol ethylene oxide-modified acrylate, nonylphenol (ethylene oxide 4 mol-modified) acrylate, nonylphenol (ethylene oxide 8 mol-modified) acrylate, nonylphenol (propylene oxide 2.5 mol-modified) acrylate, 2-ethylhexylcarbitol acrylate, ethylene oxide-modified phthalate(meth)acrylate, ethylene oxide-modified succinate(meth)acrylate, trifluoroethyl(meth)acrylate, acrylic acid, methacrylic acid, maleic acid, fumaric acid, ω-carboxy-polycaprolactone mono(meth)acrylate, phthalate monohydroxyethyl(meth)acrylate, a (meth)acrylic acid dimer, β-(meth)acryloyloxyethyl hydrogen succinate or n-(meth)acryloyloxyalkyl hexahydrophthalimide.

As (A′-2) the monofunctional (meth)acrylate monomer, it is preferred to use (A′-2-1) a hydroxyalkyl(meth)acrylate such as 2-hydroxyethyl(meth)acrylate, 2-hydroxypropyl(meth)acrylate, 3-hydroxypropyl(meth)acrylate or 4-hydroxybutyl(meth)acrylate and (A′-2-2) a (meth)acrylate other than the hydroxyalkyl(meth)acrylate in combination.

The mixing ratio of (A-2-1) hydroxyalkyl(meth)acrylate to (A′-2-2) the (meth)acrylate other than the hydroxyalkyl(meth)acrylate is preferably 15 to 80:85 to 20 (mass ratio), more preferably 25 to 60:75 to 40 (mass ratio).

The mixing ratio of (A-1) the multifunctional (meth)acrylate to (A′-2) the monofunctional (meth)acrylate is preferably 3 to 55:97 to 45 (mass ratio), more preferably 5 to 45:95 to 55 (mass ratio).

(B′) The organic peroxide is a radical polymerization initiator of an acrylate monomer, and it may, for example, be benzoyl peroxide, methyl ester ketone hydroperoxide, t-butyl hydroperoxide, di-t-butyl hydroperoxide, dicumyl peroxide, cumene hydroperoxide or p-menthane hydroperoxide. (B′) The organic peroxide is preferably cumene hydroperoxide.

The content of (B′) the organic peroxide is preferably from 0.1 to 10 parts by mass, more preferably from 1 to 8 parts by mass per 100 parts by mass of (A′) the polymerizable acrylic composition. When it is at least 0.1 part by mass, curing failure may not occur, and when it is at most 10 parts by mass, an increase in the skin irritancy or a decrease in the storage stability will not occur.

(C′) The reducing agent may, for example, be a metallic soap such as cobalt octylate, cobalt naphthenate or vanadyl acetylacetonate; a P-toluidine compound such as dimethyl-P-toluidine, diethyl-P-toluidine or diisopropanol-P-toluidine; a thiourea compound such as thiourea, acetyl thiourea, tetramethyl thiourea or ethylene thiourea; or a thioamide compound such as mercapto benzimidazole.

The content of (C′) the reducing agent is preferably from 0.04 to 5 parts by mass, more preferably from 0.08 to 3 parts by mass per 100 parts by mass of (A′) the polymerizable acrylic composition. When it is at least 0.04 part by mass, curing failure will not occur, and when it is at most 5 parts by mass, an increase in the skin irritancy or a decrease in the storage stability will not occur.

The acrylic adhesive of the present invention preferably further contains an elastomer component, in order to improve the adhesion. An elastomer component is a polymer material having rubber-like elasticity at room temperature, and is preferably soluble or dispersible in a polymerizable vinyl monomer.

Such an elastomer component may, for example, be a synthetic rubber such as acrylonitrile/butadiene rubber (NBR rubber), a linear polyurethane, styrene/butadiene rubber, chloroprene rubber or butadiene rubber, or a natural rubber; a styrene thermoplastic elastomer such as styrene/polybutadiene/styrene synthetic rubber; or an olefin thermoplastic elastomer such as polyethylene/EPDM synthetic rubber. Such elastomer components may be used alone or as a mixture of two or more of them so long as they are miscible.

Among them, preferred is acrylonitrile/butadiene rubber in view of good solubility in a polymerizable acrylic composition and good adhesive properties.

The content of the elastomer component is preferably from 5 to 40 parts by mass, more preferably from 10 to 35 parts by mass per 100 parts by mass of the total of (A′) the polymerizable acrylic composition and the elastomer component.

The acrylic adhesive the present invention may contain a dry oil. The dry oil may, for example, be a so-called glycerin ester of an unsaturated fatty acid, such as linseed oil or boiled oil.

The content of the dry oil is preferably from 0.1 to 20 parts by mass, more preferably from 2 to 10 parts by mass per 100 parts by mass of (A′) the polymerizable acrylic composition. When it is at least 0.04 part by mass, curing failure may not occur, and when it is at most 5 parts by mass, an increase in the skin irritancy or a decrease in the storage stability will not occur.

The acrylic adhesive of the present invention may contain paraffin wax.

The content of the paraffin wax is preferably from 0.3 to 3 parts by mass, more preferably from 0.5 to 2 parts by mass per 100 parts by mass of (A′) the polymerizable acrylic composition. When it is at least 0.3 part by mass, curing failure will not occur, and when it is at most 3 parts by mass, an increase in the skin irritancy or a decrease in the storage stability will not occur.

The acrylic adhesive of the present invention may contain a bulking agent.

The bulking agent of in the present invention may, for example, be an organic powder, an inorganic powder or a metallic powder.

The bulking agent of the inorganic powder may, for example, be glass balloons, Shirasu balloons, a ceramic powder, ceramic balloons, a glass powder, short fibrous glass, a silica powder, ultrafine silica, an alumina powder, a mica powder, a ceramic powder, quartz sand, sand, a rock powder, a magnesia powder, a calcium carbonate powder, a silicon carbide powder, a silicon nitride powder, an aluminum nitride powder, a carbon powder, kaolin clay, a dry clay mineral powder, a ferrite powder or a dry diatomaceous earth powder. Further, a pigment or a metal powder may, for example, be mentioned depending on the purpose of use.

The bulking agent of the organic powder may, for example, be a synthetic polymer powder such as a polyethylene powder, a polypropylene powder, a rubber powder, plastic balloons, a nylon powder, a plastic short fiber powder, a silicone rubber powder, a crosslinked acrylic powder, a crosslinked polystyrene powder, a polyester powder, a Teflon (trademark) powder, a polyvinyl alcohol powder, a polyvinyl butyral powder, a polycarbonate powder, an epoxy resin powder or a cured epoxy resin powder.

The content of the bulking agent is preferably from 10 to 30 parts by mass, more preferably from 15 to 25 parts by mass per 100 parts by mass of (A′) the polymerizable acrylic composition.

In the present invention, a small amount of an antioxidant may be added for the purpose of improving the storage stability of (B′) the organic peroxide. The antioxide may, for example, be a phenolic antioxidant such as hydroquinone, pyrogallol or monomethyl hydroquinone; p-benzoquinone or citric acid.

The content of the antioxidant is preferably from 0.001 to 1.0 part by mass, more preferably from 0.005 to 0.2 part by mass per 100 parts by mass of (A′) the polymerizable acrylic composition.

In the present invention, a small amount of an adhesion-imparting agent may be added. The adhesion-imparting agent may, for example, be γ-chloropropyl trimethoxysilane, vinyl trimethoxysilane, vinyl trichlorosilane, vinyl triethoxysilane, vinyl tris(β-methoxyethoxy)silane, γ-methacryloxypropyltrimethoxysilane, γ-acryloxypropyltrimethoxysilane, β-(3,4-epoxycylcohexyl)ethyltrimethoxysilane, γ-glycidoxypropyltrimethoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethyldimethoxysilane, γ-ureidopropyltriethoxysilane, hydroxyethyl methacrylate phosphate, methacryloxyethyl acid phosphate, methacryloxyethyl acid phosphate monoethylamine half salt or 2-hydroxyethylmethacrylate phosphate, or a methacrylate phosphate ethanolamine neutralizer. Among them, preferred is a phosphate(meth)acrylate such as hydroxyethyl methacrylate phosphate, methacryloxyethyl acid phosphate, methacryloxyethyl acid phosphate monoethylamine half salt or 2-hydroxyethylmethacrylate phosphate, or a methacrylate phosphate ethanolamine neutralizer.

The content of the adhesion-imparting agent is preferably from 0.05 to 5.0 parts by mass, more preferably from 0.2 to 2.5 parts by mass per 100 parts by mass of (A′) the polymerizable acrylic composition.

The acrylic adhesive of the present invention may contain a nitrogen-containing compound.

The nitrogen-containing compound in the present invention may, for example, be preferably an imidazole derivative, a triazine derivative or an ethanolamine derivative. Among them, an imidazole derivative or a triazine derivative is more preferred.

The imidazole derivative may, for example, be imidazole, 2-methylimidazole, 2-ethylimidazole, 2-undecylimidazole, 2-heptadecylimidazole, 2-ethyl-4-methylimidazole, 2-phenylimidazole, 2-phenyl-4-methylimidazole, 1-benzyl-2-phenylimidazole, 1,2-dimethylimidazole, 1-cyanoethylimidazole, 1-cyanoethyl-2-ethyl-4-methylimidazole, 1-cyanoethyl-2-undecylimidazole, 1-cyanoethyl-2-phenylimidazole, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2-phenylimidazole isocyanuric acid adduct, 2-phenyl-4,5-dihydroxymethylimidazole, 2-phenyl-4-methyl-5-hydroxymethylimidazole, 2,3-dihydro-1H-pyrrolo(1,2-A)benzimidazole, 4,4′-methylenebis(2-ethyl-5-methylimidazole), 2-methylimidazoline or 2-phenylimidazoline.

The triazine derivative may, for example, be 2,4-diamino-6-vinyl-s-triazine, 2,4-diamino-6-methacryloyloxyethyl-s-triazine or a triazine derivative isocyanuric acid adduct.

The ethanolamine derivative may, for example, be triethanolamine, diethanolamine, N,N′-di(ethyloxy)aniline or diethanol toluidine.

The nitrogen-containing compounds may be used as a mixture of two or more of them for the purpose of improving the handling efficiency and the performance. The amount is preferably from 0.8 to 3 mol, more preferably from 1 to 2 mol per 1 mol of (C′) the reducing agent. When it is at least 0.8 mol, adhesive properties to a metal will improve, and when it is at most 3 mol, the surface curing properties will not be low.

The primer composition of the present invention, as described above, can remarkably accelerate curing of an acrylic adhesive when contacted with the acrylic adhesive, and accordingly a bonding method which comprises applying the primer composition to a surface of an object to be bonded, and bonding the object to another object to be bonded by means of the acrylic adhesive, is possible. Particularly preferred is a boding method of applying the primer composition on a surface of an object to be bonded by dot coating, and bonding the object to another object to be bonded by means of the acrylic adhesive. By such a bonding method, a partial high speed curing bonding can be realized, whereby the pot life in the bonding operation can be adjusted to the production line, and an assembly bonded without misalignment in the position can be obtained. Further, such an assembly maintains sufficient adhesive strength and in addition, is excellent in the outer appearance.

In the above bonding method, if the primer composition is applied to the entire surface of an object to be bonded, the adhesive strength of the acrylic adhesive may be decreased in some cases. Accordingly, it is particularly preferred to partially apply the primer composition on a bonding surface by dot coating, whereby the portion coated with the primer alone can be cured quickly while strength of the acrylic adhesive is maintained.

That is, in the present invention, the primer composition can be applied to a bonding surface to an extent such that the bonding strength of the acrylic adhesive will not be decreased. According to studies by the present inventors, the effects of the present invention will be obtained when at most 70% of the entire boding surfaces of the objects to be bonded are coated, and the effects of the present invention can be securely achieved when at most 20% of the bonding surfaces are coated. Further, it is preferred to apply from 0.0001 to 0.02 g of the primer composition by dot coating on a surface of an object to be bonded having an area of 25 mm×45 mm, and it is more preferred to apply 0.0005 to 0.01 g by dot coating.

The primer composition of the present invention is preferably applied by dot coating on 1 to 3 positions on a surface of an object to be bonded having an area of 25 mm×45 mm.

The above bonding method is a method wherein the acrylic adhesive is applied to a surface (bonding surface) of one object to be bonded so that curing starts only by the adhesive, and the primer composition is applied by dot coating on a surface (bonding surface) of another object to be bonded, and both coated surfaces are bonded, so that only a portion coated with the primer composition undergoes a curing reaction at a high speed for temporarily fixing.

The primer composition of the present invention is useful as a primer for high speed curing, and is suitable in a case where bonding operation should be carried out with high productivity, since partial curing occurs cured substantially instantaneously after both the objects to be bonded are bonded, and they are temporarily fixed.

The boding method of the present invention is a bonding method which may replace welding or rivet bonding, and is applicable to various uses. It is particularly suitable for bonding the furniture using a metal such as steel or steel plate products for office articles, to which the acrylic adhesive is easily applied.

Further, the assembly of the present invention is obtained utilizing the above primer composition and bonding method. The pot life in the bonding operation is adjusted to the production line, and as a result, it is bonded without misalignment in the position, maintains sufficient bonding strength and in addition, is excellent in the outer appearance.

### Examples

Now, the present invention will be described in further detail with reference to Examples and Comparative Examples. However, it should be understood that the present invention is by no means restricted thereto.

Physical properties were measured by the following methods.

### (Bonding Strength)

Bonding test specimen: iron (“SPCC” manufactured by Test Piece)

Surface treatment of bonding test specimen: degreased with acetone

Iron/iron tensile shear strength: measured in accordance with JIS K-6855

### (Temporarily Fixing Effect Confirmation Test)

About 0.001 g of a primer composition was applied by dot coating to a large iron block for a test (200 g) (25×45×20 mm) in an atmosphere at 23° C. under a relative humidity of 50%, and from a double barreled coating gun provided with a static mixer in which a two liquid chief agent type adhesive was put, the two liquid chief agent type acrylic adhesive was flatly applied to another small iron block for a test (50 g) (25×25×8 mm). Then, the small iron block for a test was bonded to the upright large iron block for a test in a vertical direction, and the time at which no alignment in the position by its own weight occurred was approximately obtained as the temporarily fixing effect appearance time.

### Example 1

### (Preparation of Acrylic Adhesive: Agent A)

20 g of 2-hydroxyethyl methacrylate, 30 g of dicyclopentenyloxyethyl methacrylate, 10 g of benzyl methacrylate, 40 g of 1,2-polybutadiene urethane-modified dimethacrylate, 20 g of ultrafine silica powder and 1 g of paraffin wax were charged in a stainless steel container and heated to 70° C. with stirring and mixing to dissolve the paraffin wax, and then the mixture was cooled to 25° C. Then, 6 g of linseed oil and 2.4 g of cumene hydroperoxide (“PERCUMYL H80” manufactured by NOF CORPORATION) were charged, followed by mixing and stirring to obtain an agent A.

### (Preparation of Acrylic Adhesive: Agent B)

20 g of 2-hydroxyethyl methacrylate, 30 g of dicyclopentenyloxyethyl methacrylate, 10 g of benzyl methacrylate, 40 g of 1,2-polybutadiene urethane-modified dimethacrylate, 20 g of ultrafine silica powder, 1 g of paraffin wax and 0.26 g of 2-methylimidazole were charged in a stainless steel container and heated to 70° C. with stirring and mixing to dissolve the paraffin wax and 2-methylimidazole, and then the mixture was cooled to 25° C. Then, 2.4 g of cobalt octylate was charged, followed by mixing and stirring, and then 0.25 g of a methacrylate phosphate methanolamine neutralizer was added, followed by mixing and stirring to obtain an agent B.

### (Preparation of Primer Composition)

2.5 g of polyethyleneimine (manufactured by NIPPON SHOKUBAI CO., LTD., “SP-006”, number average molecular weight: 600, amine value: 20 mmol/g-solid), 50 g of a nonstyrene (non-functional group) acrylic polymer (“ARUFON UP-1000” manufactured by TOAGOSEI CO., LTD., average molecular weight: 3,000) and 50 g of isopropyl alcohol were mixed and stirred in a stainless steel container to obtain a primer composition.

### (Preparation of Test Specimen and Evaluation Results)

About 0.001 g of the primer composition prepared in Example 1 was applied to a large iron block for a test (200 g) (25 mm in width×45 mm in length×20 mm in thickness) at 2 points (coating positions: 22.5 mm from above, 5 mm from right or left, the same applies hereinafter) in an atmosphere at 23° C. under a relative humidity of 50%. Then, from a double barreled coating gun provided with a static mixer in which acrylic adhesives of the agents A and B prepared in Example 1 were put, the agents A and B (0.2 g in total) were flatly applied on another small iron block for a test (50 g) (25 mm in width×25 mm in length×8 mm in thickness). Then, the small iron block for a test was bonded to the upright large iron block for a test in a vertical direction, and a time at which no misalignment in the position by its own weight occurred was measured, whereupon it was 5 seconds. Further, after curing for one day, the iron/iron shear strength was 18 MPa.

### (Low Temperature Bonding Test)

A double barreled coating gun provided with a line mixer (manufactured by Denki Kagaku Kogyo Kabushiki Kaisha) in which the agents A and B prepared in Example 1 were put and iron test specimens were left to stand in a low temperature chamber at −30° C. one day, and then the agents A and B (0.2 g in total) were applied to one test specimen (25 mm in width×100 mm in length×1.6 mm in thickness) were applied, and about 0.001 g of the primer composition prepared in Example 1 was applied to the other iron test specimen (25 mm in width×100 mm in length×1.6 mm in thickness) at 2 positions (coating positions: 6.75 mm from above, 5 mm from right or left). Both the test specimens were bonded and as a result, they were fixed in about 10 seconds. After curing for one day, the temperature was returned to 23° C., the shear strength was measured, whereupon it was 17 MPa.

### Example 2

### (Preparation of Acrylic Adhesive: Agent A)

25 g of 2-hydroxyethyl methacrylate (“LIGHT ESTER HO” manufactured by Kyoeisha Chemical Co., Ltd.), 17 g of 2-hydroxypropyl methacrylate (“LIGHT ESTER HOP” manufactured by Kyoeisha Chemical Co., Ltd.), 35 g of phenoxyethyl methacrylate (“LIGHT ESTER PO” manufactured by Kyoeisha Chemical Co., Ltd.), 9 g of an acrylic oligomer (“BPE500” manufactured by SHIN-NAKAMURA CHEMICAL CO., LTD.) and 1 g of paraffin wax (manufactured by NIPPON SEIRO CO., LTD.) were charged in a stainless steel container and heated to 70° C. with stirring and mixing to dissolve the paraffin wax, and the mixture was cooled to 25° C. Then, 13 g of NBR rubber (“DN612P” manufactured by ZEON CORPORATION) was mixed and dissolved, and then 1 g of CIT (citric acid), 0.05 g of PBQ (p-benzoquinone) and 5 g of cumene hydroperoxide (“PERCUMYL H80” manufactured by NOF CORPORATION) were added, followed by mixing and stirring to obtain an agent A.

### (Preparation of Acrylic Adhesive: Agent B)

25 g of 2-hydroxyethyl methacrylate (“LIGHT ESTER HO” manufactured by Kyoeisha Chemical Co., Ltd.), 17 g of 2-hydroxypropyl methacrylate (“LIGHT ESTER HOP” manufactured by Kyoeisha Chemical Co., Ltd.), 35 g of phenoxyethyl methacrylate (“LIGHT ESTER PO” manufactured by Kyoeisha Chemical Co., Ltd.), 9 g of an acrylic oligomer (“BPE500” manufactured by Shin-Nakamura Chemical Co., Ltd.) and 1 g of paraffin wax (manufactured by NIPPON SEIRO CO., LTD.) were charged in a stainless steel container and heated to 70° C. with stirring and mixing to dissolve the paraffin wax, and the mixture was cooled to 25° C. Then, 13 g of NBR rubber (“DN612P” manufactured by ZEON CORPORATION) was mixed and dissolved, and then 1 g of CIT (citric acid), 0.2 g of PSN (phenothiazine), 2 g of JPA (2-hydroxyethyl methacrylate phosphate) and 0.2 g of vanadyl acetylacetonate (“VoAA” manufactured by SHINKOH KAGAKU LTD.) were added, followed by mixing and stirring to obtain an agent B.

### (Preparation of Primer Composition)

2.5 g of N,N-dimethylaminline (manufactured by Wako Pure Chemical Industries, Ltd.), 50 g of “NISSO-PB TE-2000” manufactured by Nippon Soda Co., Ltd. (both terminal methacrylate modified butadiene oligomer, average molecular weight: 2000) and 50 g of isopropyl alcohol were mixed and stirred in a stainless steel container to obtain a primer composition.

### (Preparation of Test Specimen and Evaluation Results)

Test specimens were prepared and evaluation was carried out in the same manner as in Example 1 except that the agents A and B as acrylic adhesives and the primer composition prepared in Example 2 were used. As a result, the time at which no misalignment in the position by its own weight occurred was 10 seconds. Further, the iron/iron shear strength after curing for one day was 23 MPa.

### (Low Temperature Bonding Test)

Test specimens were prepared and evaluation was carried out in the same manner as in Example 1 except that the agents A and B as acrylic adhesives and the primer composition prepared in Example 2 were used. Both the test specimens were fixed in about 13 seconds, and after curing for one day, the temperature was returned to 23° C., and the shear strength was measured, whereupon it was 18 MPa.

### Comparative Example 1

About 0.001 g of the primer composition prepared in Example 1 was applied on the entire surface of a large iron block for a test (200 g) (25 mm in width×45 mm in length×20 mm in thickness) in an atmosphere at 23° C. under a relative humidity of 50%, and from a double barreled coating gun provided with a static mixer in which the acrylic adhesives of the agents A and B prepared in Example 1 were put, the agents A and B (0.2 g in total) were flatly applied on another small iron block for a test (50 g) (25 mm in width×25 mm in length×8 mm in thickness). Then, the small iron block for a test was bonded to the upright large iron block for a test in a vertical direction, and the time at which no misalignment in the position by its own weight occurred was measured, whereupon it was 10 seconds. Further, after curing for one day, the iron/iron shear strength was 2.3 MPa, and the interfacial failure occurred.

### Comparative Example 2

### (Preparation of Acrylic Adhesive: Agent A)

An agent A was prepared in the same manner as in Example 1 except that after linseed oil and cumene hydroperoxide were charged, 0.25 g of a methacrylate phosphate ethanolamine neutralizer was added, followed by mixing and stirring.

### (Preparation of Acrylic Adhesive: Agent B)

An agent B was prepared in the same manner as in Example 1.

### (Preparation of Test Specimen and Evaluation Results)

From a double barreled coating gun provided with a static mixer in which the acrylic adhesives of the agents A and B prepared in Comparative Example 2 were put, the agents A and B (0.2 g in total) were flatly applied on a small iron block for a test (50 g) (25 mm in width×25 mm in length×8 mm in thickness) in an atmosphere at 23° C. under a relative humidity of 50%. Then, the small iron block for a test was bonded to an upright large iron block for a test (200 g) (25 mm in width×45 mm in length×20 mm in thickness in a vertical direction), and the time at which no misalignment in the position by its own weight occurred was measured, whereupon it was 15 minutes. Further, the iron/iron shear strength after curing for one day was 19 MPa.

### (Low Temperature Bonding Test)

A double barreled coating gun provided with a line mixer (manufactured by Denki Kagaku Kogyo Kabushiki Kaisha) in which the agents A and B prepared in Comparative Example 2 were put and iron test specimens were left to stand in a low temperature chamber at −30° C. one day, and then the agents A and B were applied to test specimens and the test specimens were bonded. As a result, they were bonded in about 70 minutes. After curing for one day, the temperature was returned to 23° C., and the shear strength was measured, whereupon it was 18 MPa.

### Comparative Example 3

### (Preparation of Acrylic Adhesive: Agent A)

An agent A was prepared in the same manner as in Example 2.

### (Preparation of Acrylic Adhesive: Agent B)

An agent B was prepared in the same manner as in Example 2.

### (Preparation of Test Specimen and Evaluation Results)

Test specimens were prepared and evaluation was carried out in the same manner as in Comparative Example 2 except that the agents A and B as acrylic adhesives prepared in Comparative Example 3 were used. As a result, the time at which no misalignment in the position by its own weight occurred was 6 minutes. Further, the iron/iron shear strength after curing for one day was 25 MPa.

### Examples 3 to 12

Raw materials as identified in Table 1 or 2 were mixed in a composition as identified in Table 1 or 2, and a temporarily fixing effect confirmation test was carried out. The results are shown in Tables 1 and 2.

Each of the primer compositions in Examples was prepared by mixing and stirring the components (A), (B) and (C) as identified in Table 1 or 2.

### (Preparation of Test Specimen and Evaluation Results)

Test specimens were prepared and evaluation was carried out in the same manner as in Example 1 except that the acrylic adhesive and the primer composition in each Example as identified in Table 1 or 2 were used. The time at which no misalignment in the position by its own weight occurred was measured to evaluate the temporarily fixing effect by the obtained time.

### (Stirring Efficiency Test)

Components (A), (B) and (C) as identified in Table 1 or 2 were mixed and stirred to obtain a primer composition. Evaluation standards are as follows. ◯: The components were formed into a uniform solution immediately after mixing, Δ: the stirring time was from 30 to 60 minutes until the components were formed into a uniform solution, and ×: the components were not formed into a uniform solution even after stirring for longer than 60 minutes. The obtained results are shown in Tables 1 and 2.

TABLE 1

| | | Ex. | Ex. | Ex. | Ex. | Ex. |
|---|---|---|---|---|---|---|
| | Unit | 3 | 4 | 5 | 6 | 7 |
| Isopropyl alcohol | g | 90 | 70 | 50 | 30 | 10 |
| Nonstyrene (non-functional | g | 10 | 30 | 50 | 70 | 90 |
| group) acrylic polymer | | | | | | |
| Polyethyleneimine | g | 2.5 | 2.5 | 2.5 | 2.5 | 2.5 |
| Temporarily fixing effect | sec | 5 | 5 | 5 | 5 | 15 |
| in a case of using acrylic | | | | | | |
| adhesive in Example 1 | | | | | | |
| Stirring efficiency test | | Δ | ◯ | ◯ | ◯ | ◯ |

TABLE 2

| | | Ex. | Ex. | Ex. | Ex. | Ex. |
|---|---|---|---|---|---|---|
| | Unit | 8 | 9 | 10 | 11 | 12 |
| Acetone | g | 90 | 70 | 50 | 30 | 10 |
| Both terminal methacrylate | g | 10 | 30 | 50 | 70 | 90 |
| modified butadiene oligomer | | | | | | |
| N,N-dimethylaniline | g | 2.5 | 2.5 | 2.5 | 2.5 | 2.5 |
| Temporarily fixing effect | sec | 10 | 10 | 10 | 10 | 15 |
| in a case of using acrylic | | | | | | |
| adhesive in Example 2 | | | | | | |
| Stirring efficiency test | | Δ | ◯ | ◯ | ◯ | ◯ |

### INDUSTRIAL APPLICABILITY

The primer composition, and the bonding method and the assembly using it, of the present invention, exhibit an effect such that a jig for position fixing required in prior art is no more necessary since a defect of a conventional acrylic adhesive such as poor instantaneous bonding properties is overcome, and the initial bonding properties are obtained. In addition, the time required for main curing can be shortened as compared with a conventional case, whereby the time until the composition reaches a completely cured state, required until shipping of assembled products, can be shortened, which contributes to an improvement in the line efficiency. Accordingly, the productivity can be improved, for example, in various industrial fields such as production of the furniture made of a steel plate or office articles, and the present invention is thereby industrially useful.

The entire disclosure of Japanese Patent Application No. 2007-098650 filed on Apr. 4, 2007 including specification, claims and summary are incorporated herein by reference in its entirety.

1. A primer composition for an acrylic adhesive, which comprises the following components (A), (B), and (C):
component (A): a basic compound having a primary, secondary or tertiary amine structure,
component (B): an oligomer, and
component (C): a solvent.

2. The primer composition according to claim 1, which comprises 0.5 to 5 parts by mass of the component (A), from 10 to 90 parts by mass of the component (B), and from 10 to 90 parts by mass of the component (C) based on 100 parts by mass of the total of the components (B) and (C).

3. The primer composition according to claim 1, wherein the basic compound as the component (A) is a compound having a main chain of which the skeleton is ethyleneimine.

4. The primer composition according to claim 1, wherein the basic compound as the component (A) is ethyleneimine having a number average molecular weight of from 50 to 70,000.

5. The primer composition according to claim 1, wherein the basic compound as the component (A) is ethyleneimine having an amine value of from 5 to 25 mmol/g-solid in one molecule.

6. The primer composition according to claim 1, wherein the acrylic adhesive comprises (A′) a polymerizable acrylic composition, (B′) an organic peroxide and (C′) a reducing agent.

7. The primer composition according to claim 6, wherein the acrylic adhesive comprises 100 parts by mass of (A′) the polymerizable acrylic composition, from 0.1 to 10 parts by mass of (B′) the organic peroxide, and from 0.04 to 5 parts by mass of (C′) the reducing agent.

8. The primer composition according to claim 6, wherein (A′) the polymerizable acrylic composition contains (A′-1) a multifunctional (meth)acrylate and (A′-2) a monofunctional (meth)acrylate.

9. The primer composition according to claim 8, wherein (A′-2) the monofunctional (meth)acrylate contains (A′-2-1) a hydroxylalkyl(meth)acrylate and (A′-2-2) a (meth)acrylate other than the hydroxylalkyl(meth)acrylate.

10. A bonding method, which comprises applying the primer composition as defined in claim 1 on a surface of an object to be bonded, and bonding the object to another object to be bonded by means of the acrylic adhesive.

11. The bonding method according to claim 10, wherein the application method is dot coating.

12. An assembly, which is produced by bonding objects by the bonding method as defined in claim 10.
